(19) United States
(12) Patent Application Publication
(10) Pub. No.: US 2010/0009311 A1
(43) Pub. Date: Jan. 14, 2010

(54) MOUTH GUARD

(76) Inventor: Joseph J. Pelerin, Clarkston, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/558,779

(22) Filed: Sep. 14, 2009

Related U.S. Application Data
(63) Continuation-in-part of application No. 11/624,301, filed on Jan. 18, 2007, now Pat. No. 7,607,438.
(60) Provisional application No. 60/761,890, filed on Jan. 25, 2006.
(60) Provisional application No. 60/825,276, filed on Sep. 12, 2006.

(51) Int. Cl. A61C 9/00

(52) U.S. Cl. 433/48; 433/37

(57) ABSTRACT

A mouth guard for an adult having bicuspids and canines. The mouth guard includes a tray having a trough dimensioned to receive only the bicuspids and canines of the adult human. Dental impression material is disposed in the tray which conforms to the shape of the bicuspids and canines of the adult human.

### CROSS REFERENCE TO RELATED APPLICATIONS

This application is a continuation-in-part of U.S. patent application Ser. No. 11/624,301 filed Jan. 18, 2007 and entitled “Mouth Guard”, which claims priority of U.S. Provisional Applications No. 60/761,890 filed Jan. 25, 2006 and No. 60/825,276 filed Sep. 12, 2006.

### BACKGROUND OF THE INVENTION

I. Field of the Invention

The present invention relates generally to a mouth guard to minimize teeth grinding during sleep and reduce TMJ and other jaw-related problems.

II. Description of Material Art

Many persons have the tendency of grinding their teeth while sleeping. Such grinding of the teeth is involuntary and disadvantageously results in undesirable wear of the teeth, TMJ and other jaw-related problems.

In order to minimize the damage created by grinding teeth, there have been a number of previously known mouth guards which are positioned within the mouth between the teeth on the upper and lower jaws. These previously known mouth guards separate the upper and lower jaws from each other during sleep and thus prevent the teeth from grinding against each other involuntarily during sleep.

The previously known mouth guards, however, have not proven entirely satisfactory in operation. Although the previously known mouth guards effectively eliminate teeth grinding by separating the upper and lower teeth during sleep, they do not eliminate or even significantly reduce involuntary occlusion of the teeth during sleep. Consequently, while these previously known mouth guards effectively prevent erosion of the teeth caused by grinding during sleep, such guards provide little, if any, relief from temporomandibular joint disease (TMJ) and other jaw-related problems associated with teeth grinding.

### SUMMARY OF THE PRESENT INVENTION

The present invention provides a mouth guard which overcomes the above-mentioned disadvantages of the previously known mouth guards.

In brief, the mouth guard of the present invention comprises a tray having a trough dimensioned to receive only the bicuspids and canines of an adult human. The tray is preferably constructed of a thin plastic material, such as polyethylene, although other materials may also be used.

A dental impression material is disposed within the tray. Preferably, the dental impression material comprises polycapralactone with an ethylene co-vinyl acetate additive that becomes pliable at an elevated temperature of about 135° or higher. The dental impression material, however, sets and retains its shape at human body temperature, i.e. about 100° Fahrenheit.

In order to custom fit the mouth guard to an individual wearer, the tray containing the impression material is first heated to a temperature above 135° Fahrenheit in any conventional fashion, such as by immersing the tray in hot water. Once the impression material becomes pliable, the tray is positioned within the wearer's mouth so that the tray extends over the bicuspids and canines of the adult human. The wearer then occludes into the now pliable impression material and the impression material is then allowed to cool and set. Thereafter, the impression material frictionally retains the tray in position in the mouth during use.

In use, the occlusion of the teeth by a wearer during sleep will concentrate the force of the occlusion to the bicuspids and canines. This concentrated force in turn creates a reflex action of opening the jaws and releasing the pressure caused by the occlusion.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a dental tray;

FIG. 2 is a view similar to FIG. 1, but illustrating the dental tray filled with an impression material;

FIG. 3 is a front view of the preferred embodiment of the invention prior to the formation of the impression in the impression material;

FIG. 4 is a view similar to FIG. 3, but illustrating the depression formed in the impression material; and

FIG. 5 is a view taken along line 5-5 in FIG. 4 and enlarged for clarity.

### DETAILED DESCRIPTION OF A PREFERRED EMBODIMENT OF THE PRESENT INVENTION

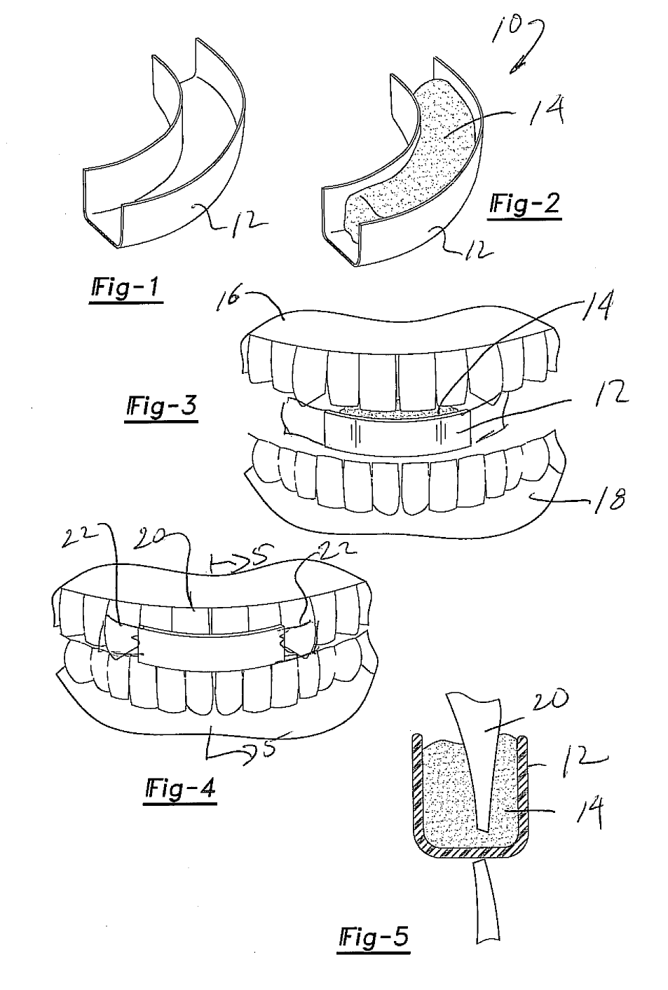

With reference first to FIGS. 1 and 2, a preferred embodiment of a mouth guard 10 according to the present invention is illustrated. The mouth guard includes a tray 12 which is dimensioned to receive only the bicuspids and canines of an adult human. As such, the tray 12 extends only for a partial arch within the mouth.

Any conventional material may be used to form the tray 12. However, preferably a thin plastic material, such as polyethylene, is used to form the tray 12. Such a plastic material, furthermore, is known to be safe for use in the human mouth.

With reference now particularly to FIG. 2, a dental impression material 14 is disposed within the tray 12. This dental impression material is preferably a polycapralactone-based material. The polycapralactone material may include an ethylene co-vinyl acetate additive in order to increase the flexibility of the polycapralactone material at temperatures present in the human mouth, i.e. typically about 100° Fahrenheit.

Other materials, however, may alternatively be used as the dental impression material 14. For example, the dental impression material may comprise a polyvinyl silicone or other silicone-based material.

With reference now to FIGS. 3 and 4, the dental impression tray 12 with its impression material 14 is first heated to an elevated temperature, e.g. above 135° Fahrenheit, at which the dental impression material 14 becomes pliable. Any conventional method may be used to heat the tray 12 and the impression material 14, such as by immersing the tray 12 with its dental impression material 14 in hot water.

After the dental impression material 14 has become pliable, the tray 12 with the impression material 14 is positioned between the upper jaw 16 and lower jaw 18 of an adult human. Furthermore, the tray 12 is positioned relative to the upper jaw so that the tray 12 is aligned with only the bicuspids and canines of the adult human.

While the dental impression material 14 is still in a pliable state, the mouth guard wearer occludes into the tray as shown in FIG. 4 and FIG. 5 so that the bicuspids 20 and canines 22 plunge into the dental impression material 14 and the dental impression material 14 conforms to the bicuspids and canines as best shown in FIG. 5. The dental impression material 14 is then allowed to cool to the temperature of a human mouth or below, e.g. 100° Fahrenheit, so that the dental impression in the impression material 14 sets and is retained by the dental impression material 14.

Thereafter, the mouth guard 10 is positioned in the mouth as shown in FIG. 4 during sleep. The mouth guard 10 separates the upper and lower teeth from each other which prevents teeth grinding. Just as importantly, however, involuntary occlusion by the wearer during sleep will concentrate pressure of the occlusion to the upper front teeth of the wearer. This, in turn, reflectively causes the wearer to open his or her jaw thus relieving the pressure caused by the occlusion. In doing so, jaw disease, such as TMJ, that otherwise is caused by involuntarily occlusion is prevented.

From the foregoing, it can be seen that the present invention provides a simple and yet highly effective mouth guard which not only prevents the wearer from grinding his or her teeth at night, but also prevents or at least greatly reduces the likelihood of jaw disease, such as TMJ, which is caused by involuntary occlusion. Having described my invention, however, many modifications thereto will become apparent to those skilled in the art to which it pertains without deviation from the spirit of the invention as defined by the scope of the appended claims.

I claim:

1. A mouth guard for an adult having bicuspids and canines comprising:
a tray having a trough dimensioned to receive only the bicuspids and canines of the adult human,
dental impression material disposed in said trough which conforms to the shape of the bicuspids and canines of the adult human.

2. The invention as defined in claim 1 wherein said impression material comprises polycapralactone.

3. The invention as defined in claim 1 wherein said impression material comprises polycapralactone with an ethylene co-vinyl acetate additive.

4. The invention as defined in claim 1 wherein said impression material comprises polyvinyl silicone.

5. The invention as defined in claim 1 wherein said tray comprises polyethylene.
